(19) United States
(12) Patent Application Publication
(10) Pub. No.: US 2015/0135852 A1
(43) Pub. Date: May 21, 2015

(54) BATTERY-FREE METER FOR FLOWING MEDIA

(71) Applicant: Hengstler GmbH, Aldingen (DE)

(72) Inventors: George Efimov, Trossingen (DE); Michael Mixner, Villingen-Schwenningen (DE)

(73) Assignee: Hengstler GmbH, Aldingen (DE)

(21) Appl. No.: 14/402,227

(22) PCT Filed: Apr. 25, 2013
(86) PCT No.: PCT/EP2013/001249

§ 371 Date: Nov. 19, 2014

(30) Foreign Application Priority Data
May 19, 2012 (DE) 102012009962.2

(51) Int. Cl. G01F 1/58; G01F 1/115

(52) U.S. Cl. CPC G01F 1/586; G01F 1/115
USPC 73/861.78

(57) ABSTRACT

Battery-free meter for flowing media, in which a rotor body (sleeve 4) which is fitted with permanent magnets (6, 7) and is driven in a rotary fashion by the medium is arranged in the pipeline (34) carrying the flowing medium (8) and in which the rotating magnetic field generated by this acts on at least one Wiegand sensor (25, 26), which is arranged outside the flowing medium in the area around the meter, wherein a housing part (15) which is open on at least one side sealing to the interior of the pipeline (34) engages with the pipeline (34) and around which the flowing medium at least partially flows, such that the external periphery of the housing part (15) is at least partially embraced by the rotor part (sleeve 4) which is driven in a rotary fashion and generates the rotating magnetic field and that at least one Wiegand sensor (25, 26) is arranged in the housing part (15).

The invention relates to a battery-free meter for flowing media according to the preamble of claim 1.

With the subject matter of U.S. Pat. No. 6,612,188 B2 a battery-free meter for flowing media has become known in which the disc which is fitted with permanent magnets and driven in rotation by the medium is disposed in the flowing medium. The Wiegand effect sensor which is necessary for generation of electrical energy is disposed outside the flowing medium in the region surrounding the counter.

A disadvantage of this arrangement is that only one single Wiegand effect sensor is provided. Thus it is not possible to construct a redundant system with two Wiegand effect sensors operating independently of one another.

Moreover the expression “Wiegand effect sensor” is synonymous with the expression “pulse wire motion sensor”. For the sake of simplicity only the first-mentioned expression is used in the following description.

In the subject matter of U.S. Pat. No. 6,612,188 B2 an arrangement of two Wiegand effect sensors disposed spaced apart from one another is not possible, because the permanent magnetic field would be too weak to pass through both Wiegand effect sensors.

With the subject matter of EP 0 724 712 B1 a further rotation angle sensor with battery-free operation is known, wherein three Wiegand effect sensors are provided which are disposed in the permanent magnetic field of a rotating disc. However, a disadvantage of this arrangement is that such a measuring arrangement is not suitable for gas or water meters, because a separation between the flowing medium and the permanent magnet disc on the one hand and the Wiegand effect sensors on the other hand is not provided.

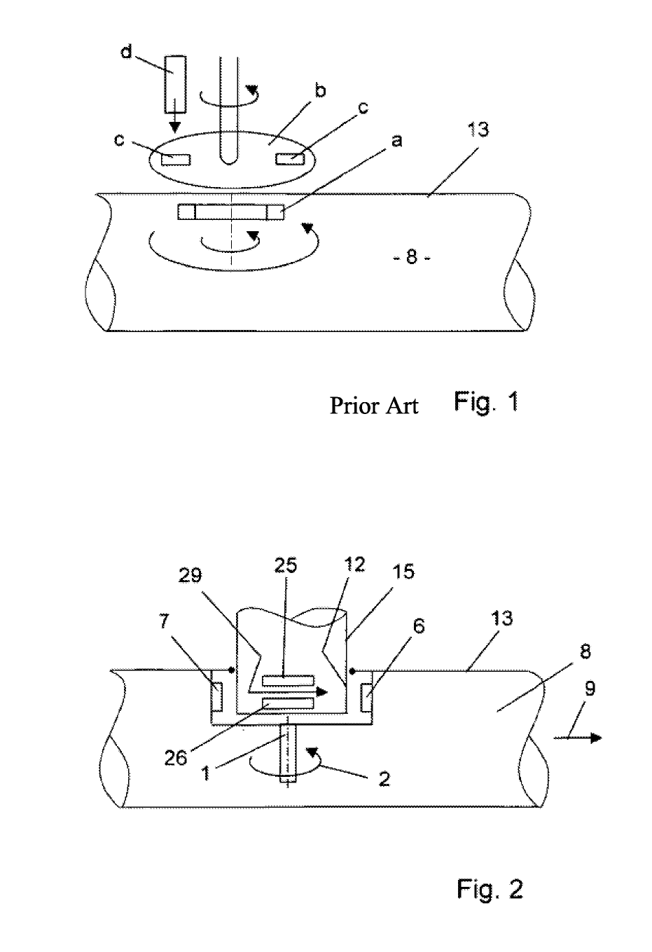

A rotation angle sensor, in which a disc fitted with permanent magnets is driven in rotation by the fluid stream, is shown as prior art in FIG. 1. The magnetic field lines pass through the media partition and drive a second magnet which is entrained by the first rotating magnetic field via a magnetic coupling in order thus to act on a Wiegand effect sensor in this region by scanning of the second rotating magnet located outside the medium. This enables a battery-free supply of the circuit.

A disadvantage of the known application principle is the magnetic coupling which is associated with high costs and can be influenced very easily from the exterior by external magnetic fields, which is undesirable in the construction of gas or water meters.

A further disadvantage with the prior art according to FIG. 1 is that movable parts are disposed in the outer region, which is undesirable.

Therefore the object of the invention is to modify a battery-free meter for flowing media, in particular gas or water, so that no rotatable parts are disposed outside the flowing medium and a magnetic influence applied from the exterior does not lead to an impairment of the metering function.

In order to achieve the stated object the invention is characterized by the technical teaching of claim 1.

It is a feature of the invention that a flowing medium drives a mechanism which generates a movement (preferably a rotational movement). This (rotational) movement is used to change a magnetic field or the magnetic field direction. Either magnets are connected to the moving element or the sensor system moves while the magnets are stationary.

A Wiegand effect sensor detects these changes of magnetic field direction and generates a current pulse with each change. This current pulse is detected and counted by a circuit. The current meter reading is stored in the circuit and can be read off later by external reading devices and further processed (for example transmitted by wireless means or presented in the conventional display).

The current pulse of the Wiegand effect sensor is sufficient as a current supply for the circuit for these operations; therefore the circuit functions without an external current supply. The magnetic field design is defined for optimal use (working temperature, field strength, field homogeneity etc.).

In addition to the current supply for the circuit, further sensor elements can be operated with the generated Wiegand energy. With these further sensor elements (for example, Hall effect sensors) it is also possible to detect the direction of rotation. Depending upon the direction of rotation the meter reading stored in the circuit with each pulse is changed by a positive or negative increment.

A prerequisite for the production of a redundant system and detection of the malfunction is that at least two Wiegand effect sensors are disposed through which the same magnetic field flows.

Safety monitoring can be implemented by a multiplication of the systems. This can take place for example by comparison of the meter readings of redundant systems with at least two Wiegand effect sensors operating independently of one another.

In the event of malfunction of one Wiegand effect sensor, the values which are generated by both Wiegand effect sensors are no longer plausible. In this way it can be ascertained whether a Wiegand effect sensor has malfunctioned.

Furthermore the service life of the application can be prolonged by further systems if one or more redundant systems can be omitted.

Further characteristics which can be achieved by the system according to the invention are:

a) The magnetic field changes can advantageously be detected through a membrane (housing wall). Thus the sensor can be disposed outside the medium to be detected or metered. The sensor system is shielded by the membranes (housing wall) against aggressive media or high pressures (also suitable for explosion protection).
b) The sensor per se is completely wear-free, contactless and non-reactive.
c) As is shown later in the drawing according to FIG. 2, with a specific arrangement of the magnets a homogeneous magnetic field can be generated for the Wiegand effect sensor system in the “interior”. Through the arrangement of the sensor system in the “interior” the sensor system can be simultaneously shielded against attempts at manipulation from the “exterior”.
d) Such systems are suitable particularly for recording consumption in the case of flowing media (such as for example in gas and water meters).
e) The calibration of battery-free meters, counting devices, pulse counters and measuring devices for flowing media can be omitted.

In addition to the actual functioning of a battery-free meter the following further advantages are achieved according to the invention:

1) +In the invention the Wiegand-Hall effect sensor unit is doubled. The systems can monitor one another reciprocally by comparison thereof. If, for example, one system is manipulated this can be detected by the other one. If one system malfunctions or is damaged, this malfunction can also be recognized by comparison of the values of the other system.

Due to the double circuit as OR operation consisting of two independently operating Wiegand effect sensors, the service life is increased.

2) The arrangement of the rotating shaft with magnets externally and the Wiegand effect sensors internally produces two advantages:
a) an almost homogeneous magnetic field for the Wiegand effect sensors in the interior (comparison of FIG. 1/3 with FIG. 2).
b) The shaft can simultaneously shield the Wiegand effect sensors in the interior or possibly keep external noise magnets from the exterior at a distance—security against manipulation.
3) The complete arrangement of the circuit board in the interior of, for example, the gas meter additionally increases the degree of security against manipulation (FIG. 1). Detecting elements and circuits are disposed far away from the accessible outer region of the meter.
4) A compact arrangement is also possible. For this purpose the pairs of magnets are rotated by 90° on the shaft. Thus only two parallel circuit boards are necessary instead of four or five as in another embodiment.
5) Wiegand and Hall effect sensors are disposed so that recognition of a direction of rotation is ensured.
6) Change of magnetic field through the membrane. Thus the sensor can be disposed outside the medium to be detected or metered (aggressive media, pressures, explosive gases).
7) No sensor wear—because it is contactless.
8) Since a battery change is never necessary there is no need for any calibration at a later stage.
9) A solution with a circuit board is also possible.

Accordingly, a significant feature of the invention is that a housing extends in a sealing manner into the interior of the flowing medium, in which housing at least one, but preferably two, Wiegand effect sensors are disposed, and that only the disc which is moved by permanent magnets and preferably constructed as a sleeve, and which generates a necessary magnetic field with respect to the Wiegand effect sensors which encroach in a sealing manner into the flowing medium in the housing, is disposed in the flowing medium.

The housing accommodates in its interior the sensor system with the at least one Wiegand effect sensor and extends into the pipeline with its longitudinal axis approximately transversely (approximately at an angle of 90°) with respect to the longitudinal axis of the pipeline. The interior of the housing is therefore not acted upon by the medium, but by the atmosphere surrounding the pipeline. Therefore it may preferably be constructed so that it is open on one side in the direction towards the atmosphere in order to obtain good access to the sensor system installed there.

The expression “transverse field” is understood to mean that a rotating magnetic field is generated, of which the field lines extend parallel to the flowing medium and rotate, i.e. a rotating magnetic field is generated in the plane of the Wiegand wires, producing the advantage that in the most confined space it is possible to dispose not only one single Wiegand effect sensor but also two Wiegand effect sensors or even more, through all of which the same transverse magnetic field passes with approximately the same magnetic field strength, which was not possible in the prior art.

In the prior art one or more Wiegand sensors were disposed vertically one above the other (in a stack), whereas the central focus of the present invention is that a magnetic field disposed radially outside the housing flows through the Wiegand sensors with the Wiegand wires oriented in this plane.

Accordingly, instead of a structure according to the prior art in which the Wiegand effect sensors lie one above the other, the invention provides a vertical arrangement of the Wiegand effect sensors in a plane.

The subject matter of the present invention is revealed not only by the subject matter of the individual claims, but also the combination of the individual claims with one another.

All the details and features disclosed in the documents, including the abstract, in particular the spatial configuration illustrated in the drawings, are claimed as essential to the invention in so far as they are individually or in combination novel over the prior art.

The invention is explained in greater detail below with reference to drawings which show several embodiments. In this case the drawings and the description thereof illustrate further features and advantages which are essential to the invention.

In the drawings:

FIG. 1 shows an arrangement according to the prior art;

FIG. 2 shows a schematic block wiring diagram of the principle of the invention;

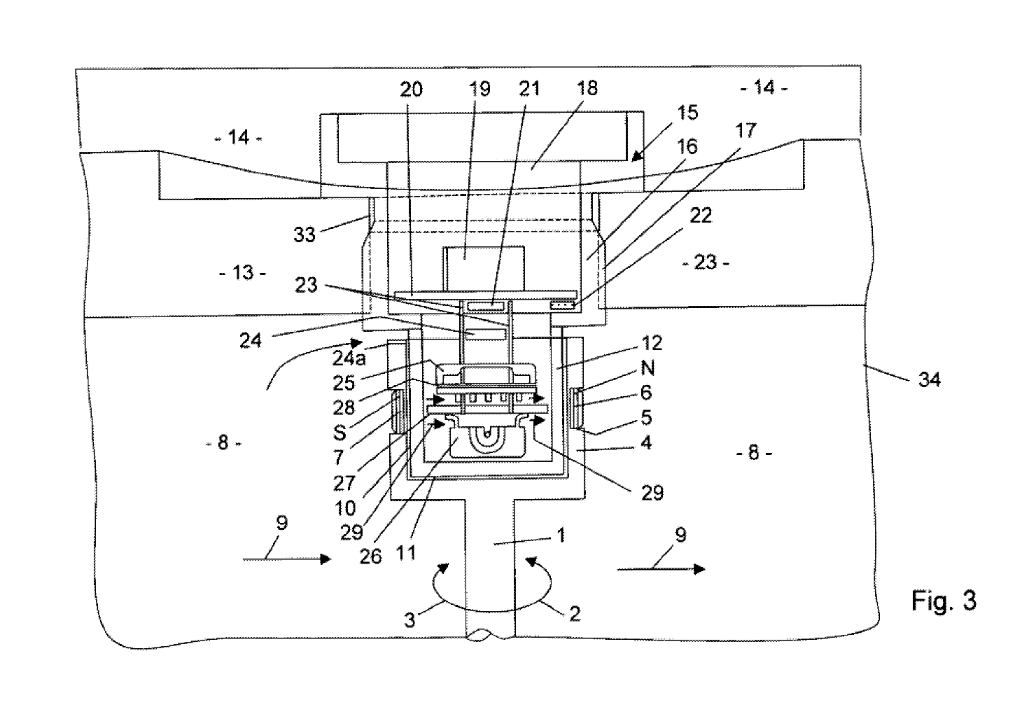

FIG. 3 shows a half-section through the pipeline conveying the medium with a representation of a first embodiment of the invention;

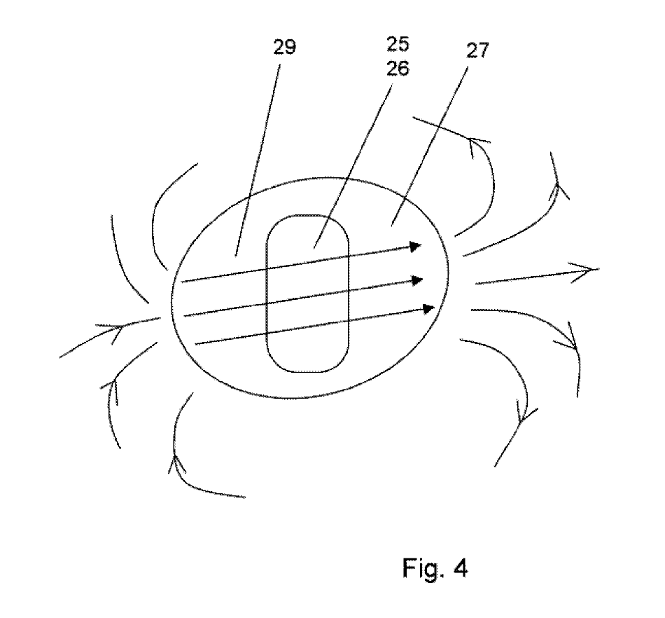

FIG. 4 shows a block diagram of the magnetic flux;

FIG. 5 shows a second embodiment of the invention;

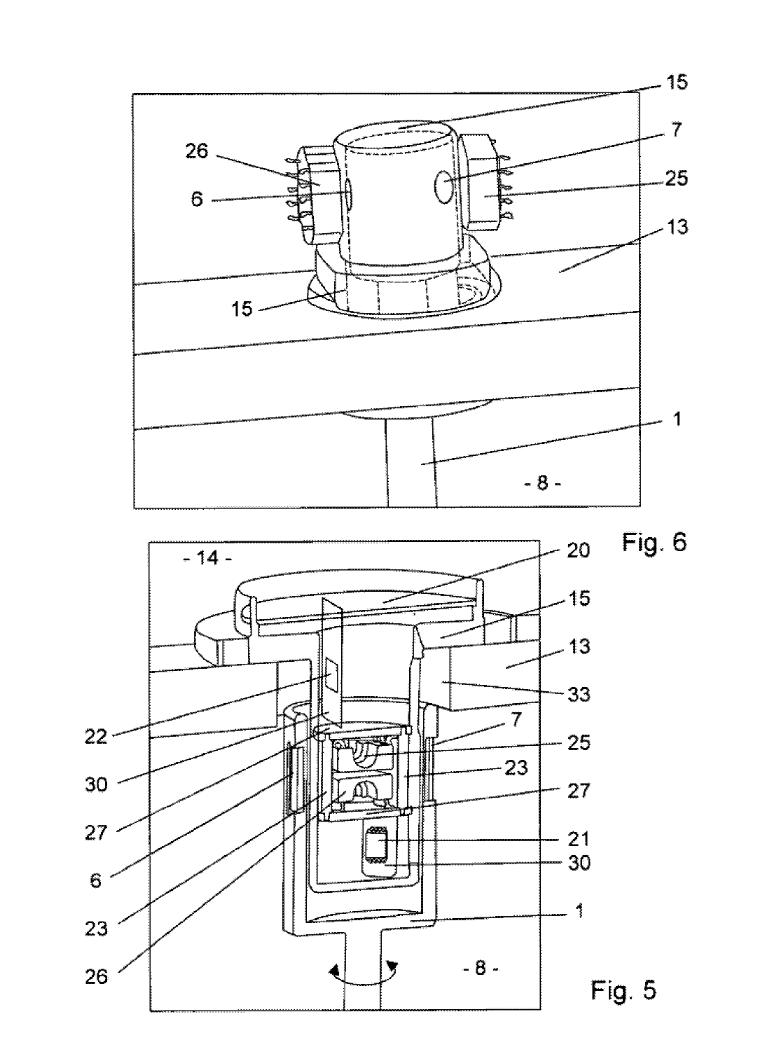

FIG. 6 shows a third embodiment of the invention;

FIG. 1 shows schematically according to the prior art that a disc a fitted with permanent magnets rotates in the flowing medium 8 and in so doing generates a magnetic field through the partition 13 of the medium on a further rotatable disc b which is disposed outside the medium and is fitted with one or more permanent magnets c, wherein a magnetic rotary coupling exists between the disc a and the disc b.

Due to the rotation of the disc a, by means of the magnetic coupling the disc b is rotatably entrained and a Wiegand effect sensor d, of which the Wiegand wire is acted upon by the permanent magnetic field of the permanent magnet c, is disposed in the vicinity of the disc b, so that a voltage pulse is generated in the event of a change of field direction.

A disadvantage of the known arrangement is the magnetic coupling through the partition 13 of the flowing medium 8.

The fundamental principle of the invention is illustrated in FIG. 2. According to the invention a housing part 15 with an inner bushing 12 penetrates into the flowing medium 8. Two Wiegand effect sensors 25, 26, which are spaced apart from one another and through which the field lines 29 of the transverse magnetic field pass, are preferably disposed in the inner bushing.

The transverse magnetic field is generated by a plurality of permanent magnets 6, 7 which are uniformly distributed on the circumference and are disposed on a sleeve 4 which rotates for example in the direction of the arrow 2 and is non-rotatably connected to a drive shaft 1.

The drive shaft 1 is driven by means of a driving device (not illustrated in greater detail), for example a turbine wheel or the like which can be disposed directly in the flowing medium 8.

In the invention it is important that a magnetic coupling according to the prior art illustrated in FIG. 1 can be omitted, so that a completely sealed closure of the housing part 15 with respect to the flowing medium 8 is provided. Only the rotatably driven sleeve 4, and not the entire counting unit, is located in the flowing medium. In the US patent specification it was necessary that the entire meter device is installed so that it is encapsulated in the flowing medium, which is avoided in the invention.

A further advantage of the invention is that because of the parallel arrangement of the field lines 29 in a plane (parallel to the flow direction of the flowing medium 8) it is now possible to dispose in this plane two or more Wiegand effect sensors 25, 26 which are located one above the other and through all of which the field lines 29 of the rotating magnetic field flow in the same way, because they are located substantially vertically one above the other in one plane.

In a preferred further configuration of the invention it is additionally provided that one or more Hall effect sensors are provided by which the direction of rotation can be recognized.

In this connection it is preferred if in addition to the rotating magnetic field an additional magnetic field is disposed in the part fixed to the housing, i.e. within the housing.

In this modification of the invention it is provided that a recognition of a direction of rotation is provided, for which at least one Wiegand effect sensor in combination with a Hall effect sensor is necessary.

In order to configure the arrangement to be redundant, according to the invention two Wiegand effect sensors are provided and a Hall effect sensor is associated with each Wiegand effect sensor.

For each Wiegand effect sensor and for each associated Hall effect sensor a measurement evaluation is carried out so that there are two separate measurement evaluations. If one Wiegand effect sensor or a Hall effect sensor associated therewith malfunctions, this is recognized, and the measurement results of the other Wiegand effect sensor are evaluated in conjunction with the Hall effect sensor associated therewith.

For such a case of malfunction it may also be provided that the entire meter is replaced.

In any case a redundant arrangement of a respective Wiegand effect sensor with a Hall effect sensor is present, in order to configure this system so as to be particularly operationally reliable.

FIG. 3 shows that a drive shaft 1 is present in the flowing medium 8 which for example flows in the direction of the arrow 9. In this case the drive shaft 1 can be driven in this case in the direction of the arrow 2, but also in the opposite direction, in the direction of the arrow 3.

The drive shaft 1 is preferably integrally connected to a cup-shaped sleeve 4, on the external circumference of which a plurality of permanent magnets 6, 7 are uniformly distributed. In a preferred embodiment two permanent magnets 6, 7 are disposed opposite one another on the external circumference. However, more than two permanent magnets can also be provided.

It is important that one permanent magnet 6 points radially outwards with its north pole, whereas the opposing permanent magnet 7 points radially outwards with its south pole. These have opposed polarities. Instead of the two permanent magnets 6, 7 present, further permanent magnets can also be disposed in pairs; i.e. for example four permanent magnets or six or eight.

These permanent magnets 6 are in each case disposed in recesses 5, distributed on the circumference, in the wall of the sleeve 4 and generate a transverse field, as shown by the field lines 29 in FIG. 4. This is also illustrated in FIG. 3. It can be seen there that the rotating field which is generated by the rotating sleeve 4 passes transversely through the internal housing 15 which constitutes the meter.

The housing part 15 is inserted in a sealed manner in a partition 13 and extends with a bushing-like housing part (inner bushing 12) in a sealed manner into the flowing medium 8.

The interior 18 of the housing communicates with the neutral surroundings 14 and does not have to be (but may be) in particular sealed. This is a significant advantage over the prior art.

The rotatably driven sleeve 4 rotates by means of a circumferential annular gap 10 and a bottom gap 11 with regard to the fixed inner bushing 12.

On the top end face of the sleeve 4 a plurality of permanent magnets 24, 24a are non-rotatably disposed on the external circumference and form the signal generators for the Hall effect sensors 21, 22 which are disposed in the interior 18 of the housing 15 and are used for recognition of a direction of rotation. Each Hall effect sensor 21, 22 is constructed independently of the other and carries out an independent evaluation in order to achieve the aforementioned redundant systems which operate independently of one another.

A first system is produced for example by the upper Wiegand effect sensor 25 in conjunction with for example the Hall effect sensor 21, whereas the second measuring system, which evaluates independently and also operates independently, is formed by the second Wiegand effect sensor 26 in conjunction with the Hall effect sensor 22.

Redundant evaluation electronics, of which no further mention is made here, are associated with the measurement sensors.

The two Wiegand effect sensors 25, 26 are separated from one another in the interior of the inner bushing 12 by connecting pins 23. A central circuit board 27 is provided on which the two Wiegand effect sensors 25, 26 are disposed. It is shown only by way of example that a Wiegand wire 28 in which the electrical voltage is induced is associated with each Wiegand effect sensor 25, 26 in a manner which is known per se.

The inner bushing 12 extends integrally upwards with an increased diameter in the form of a wall socket 16, wherein the wall socket 16 with an external thread 17 is received in a sealing manner in an associated receiving bore 33 in the partition 13.

In this region a further circuit board 20 is disposed above the connecting pins 23 and carries a terminal block 19 in which the measurement electronics and the connecting parts are integrated.

FIG. 5 shows a further embodiment. This embodiment differs from the embodiment according to FIG. 3 in that the components are positioned differently. The Wiegand effect sensors 25, 26 are disposed in a more confined space and are kept spaced apart by connecting pins 23. In the lower region there is a circuit board 27 below which one Hall effect sensor 21 is disposed by means of a further circuit board 30, whereas the opposing Hall effect sensor is disposed on an upper circuit board 20 in the region of an upper circuit board 30 offset with respect thereto in the form of the Hall effect sensor 22.

Accordingly the two Hall effect sensors 21, 22 are offset obliquely relative to one another at different levels from one another and operate with respective permanent magnets which are disposed on these planes which in each case are disposed non-rotatably in the circumferentially driven sleeve 4. The permanent magnets are not illustrated for the sake of simplicity.

Although a plurality of circuit boards are provided in this embodiment, the representation according to FIG. 5 shows that the proportion of the housing 15 which in the form of the inner bushing 12 penetrates into the medium 8 is larger, comparatively, than in the embodiment according to FIG. 3 and that in the embodiment according to FIG. 5 only small housing parts are provided in the outer region beyond the partition 13.

In the embodiment according to FIG. 5 this results in an improved magnetic shielding of the housing 15, because the entire structure penetrates into the medium 8 and a magnetic field applied from the exterior and intended for manipulation purposes has a less effective action on the measuring arrangement according to FIG. 5.

A third embodiment is illustrated in the exemplary embodiment according to FIG. 6, in which beyond the partition 13 a high housing part 15 is provided, on the external circumference of which the Wiegand effect sensors 25, 26 are disposed which in the previous example are disposed in the interior of the housing.

The difference here resides in the fact that the Wiegand effect sensors can also be disposed outside the housing and are influenced by the permanent magnets 6, 7 which are disposed in an inner circumferential sleeve inside the housing 15. This shows the opposite design by comparison with FIG. 5, because the essential part of the housing structure is disposed in the region of the neutral surroundings 14, whereas according to FIG. 5 the essential part of the housing is disposed in the region of the flowing medium 8.

In the embodiment according to FIG. 6 there is a further advantage in that the diameter of the housing 15 can be further minimized, because the Wiegand effect sensors are located radially externally and there is no need—as in FIG. 5—to install the Wiegand effect sensors extensively in the region of an inner sleeve 12 which penetrates into the medium and provides a seal there.

According to FIG. 6 a substantial minimization of the housing dimensions can be carried out by comparison with the housing according to FIG. 5.

FIG. 7 shows a sectional representation through the drawing according to FIG. 3, from which further details of the structure can be seen.

### KEY TO DRAWINGS

1 drive shaft
2 direction of the arrow
3 direction of the arrow
4 sleeve (outer)
5 recess
6 permanent magnet
7 permanent magnet
8 medium
9 direction of the arrow
10 annular gap
11 bottom gap
12 inner bushing
13 partition
14 surroundings
15 housing part
16 wall socket
17 external thread
18 interior
19 terminal block
20 circuit board
21 Hall effect sensor 1
22 Hall effect sensor 2
23 connecting pin
24 permanent magnet 24a
25 Wiegand effect sensor 1
26 Wiegand effect sensor 2
27 circuit board
28 Wiegand wire
29 field line of the homogeneous magnetic field
30 circuit board
33 receiving bore (in 13)
34 pipeline

1. Battery-free meter for flowing media, in which a rotor body (sleeve 4) fitted with permanent magnets (6, 7) and driven rotatably by the medium is disposed in the pipeline (34) conveying the flowing medium (8), and the rotating magnetic field generated thereby acts on at least one Wiegand effect sensor (25, 26) which is disposed outside the flowing medium in the region surrounding the meter, wherein approximately transversely with respect to the longitudinal axis of the pipeline (34) a housing part (15) engages in a sealing manner in the interior of the pipeline (34) and is at least partially flowed around by the flowing medium, the external circumference of the housing part (15) is at least partially surrounded by the rotor part (sleeve 4) which is driven in rotation and generates the rotating magnetic field, and at least one Wiegand effect sensor (25, 26) is disposed in the housing part (15), wherein in addition to the rotating magnetic field an additional magnetic field is provided which emanates from at least one permanent magnet (24, 24a) which is non-rotatably disposed on the top end face on the external circumference of the sleeve (4) and is configured as a signal generator for the recognition of a direction of rotation for at least one Hall effect sensor (21, 22) disposed in the interior (18) of the housing (15).

2. Battery-free meter according to claim 1, wherein for recognition of a direction of rotation a Hall effect sensor (21, 22) is associated with at least one Wiegand effect sensor.

3. Battery-free meter according to claim 1, wherein the field lines (29) of the rotating permanent magnetic field pass in the plane or direction (9) of the fluid medium (8) through the at least one Wiegand effect sensor (25, 26) or the sensor element which recognizes the direction.

4. Battery-free meter according to claim 1, wherein the rotating magnetic field generated by the permanent magnets (6, 7) is oriented with its field lines (29) parallel to the flowing medium (8) and the rotating magnetic field formed in this way is located in the plane of the Wiegand effect sensor (25, 26), so that two Wiegand effect sensors (25, 26), through all of which the same transverse magnetic field with approximately the same magnetic field strength passes, are also to be disposed in the most confined space.

5. Battery-free meter according to claim 1, wherein the current pulse of the at least one Wiegand effect sensor (25, 26) is sufficient for the current supply to the circuit of the meter.

6. Battery-free meter according to claim 5, wherein in addition to the current supply to the circuit with the at least one Wiegand effect sensor (25, 26) further sensor elements, for example one or more Hall effect sensors (21, 22) can be operated for the recognition of a direction of rotation.

7. Battery-free meter according to claim 1, wherein two Wiegand effect sensors (25, 26) are provided which operate independently of one another with associated circuits and form a redundant circuit configuration.

8. Battery-free meter according to claim 1, wherein for each Wiegand effect sensor (25, 26) and for each associated Hall effect sensor (21, 22) a measurement evaluation is carried out so that there are two separate measurement evaluations which are compared with one another.

9. Battery-free meter according to claim 1, wherein the drive shaft (1) disposed in the flowing medium (8) is connected to a cup-shaped sleeve 4, on the external circumference of which a plurality of permanent magnets (6, 7) are uniformly distributed.

10. Battery-free meter according to claim 9, wherein the permanent magnets (6, 7) have opposing polarities, wherein one permanent magnet (6) points radially outwards with its north pole, whereas the opposing permanent magnet (7) points radially outwards with its south pole.
